(19) United States
(12) Patent Application Publication
(10) Pub. No.: US 2025/0322288 A1
(43) Pub. Date: Oct. 16, 2025

(54) METHODS, SYSTEMS, AND DEVICES FOR SCALABLE MACHINE LEARNING MODEL INFRASTRUCTURE

(71) Applicant: JPMorgan Chase Bank, N.A., New York, NY (US)

(72) Inventor: Sandeep K. Maji, Old Bridge, NJ (US)

(73) Assignee: JPMorgan Chase Bank, N.A., New York, NY (US)

(21) Appl. No.: 18/633,091

(22) Filed: Apr. 11, 2024

(51) Int. Cl. G06N 20/00

(52) U.S. Cl. CPC G06N 20/00

(57) ABSTRACT

Aspects of the subject disclosure may include, for example, obtaining a processing capacity associated with a machine learning model and obtaining a memory capacity associated with the machine learning model, and obtaining a processing capacity threshold and obtaining a memory capacity threshold. Further embodiments include provisioning a head node and a first group of worker nodes based on the processing capacity, the memory capacity, the processing capacity threshold, and the memory capacity threshold, provisioning a first portion of data engineering pipeline on each of the first group of worker nodes, and provisioning a first portion of the machine learning model on each of the first group of worker nodes. Other embodiments are disclosed.

### FIELD OF THE DISCLOSURE

The subject disclosure relates to methods, systems, and devices for scalable machine learning model infrastructure.

### BACKGROUND

In the current state of the art, machine learning (ML) operations comprise a framework that includes provisioning a single data engineering entity and a single ML engineering entity. However, such a provisioning allocates enough processing capacity and memory capacity of the computing system implementing the framework to deal with high intensive projects (e.g., in processing capacity and memory capacity) as well as medium intensive and low intensive projects. Thus, there is inefficient use of processing and memory resources in such a framework when implementing medium intensive and low intensive projects.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of the prior art.

FIGS. 2A-2B are block diagrams illustrating an exemplary, non-limiting embodiments of a scalable machine learning model infrastructure in accordance with various aspects described herein.

FIG. 3 depicts an illustrative embodiment of a method in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for obtaining a processing capacity associated with a machine learning model and obtaining a memory capacity associated with the machine learning model, and obtaining a processing capacity threshold and obtaining a memory capacity threshold. Further embodiments can include provisioning a head node and a first group of worker nodes based on the processing capacity, the memory capacity, the processing capacity threshold, and the memory capacity threshold, provisioning a first portion of data engineering pipeline on each of the first group of worker nodes, and provisioning a first portion of the machine learning model on each of the first group of worker nodes. Other embodiments are described in the subject disclosure.

One or more aspects of the subject disclosure include a device, comprising a processing system including a processor, and a memory that stores executable instructions that, when executed by the processing system, facilitate performance of operations. The operations can comprise obtaining a processing capacity associated with a machine learning model and obtaining a memory capacity associated with the machine learning model, and obtaining a processing capacity threshold and obtaining a memory capacity threshold. Further operations can comprise provisioning a head node and a first group of worker nodes based on the processing capacity, the memory capacity, the processing capacity threshold, and the memory capacity threshold, provisioning a first portion of data engineering pipeline on each of the first group of worker nodes, and provisioning a first portion of the machine learning model on each of the first group of worker nodes.

One or more aspects of the subject disclosure include a non-transitory machine-readable medium, comprising executable instructions that, when executed by a processing system including a processor, facilitate performance of operations. The operations can comprise obtaining a processing capacity associated with a machine learning model and obtaining a memory capacity associated with the machine learning model, and provisioning a head node and a first group of worker nodes based on the processing capacity, and the memory capacity. Further operations can comprise provisioning a first portion of data engineering pipeline on each of the first group of worker nodes, and provisioning a first portion of the machine learning model on each of the first group of worker nodes.

One or more aspects of the subject disclosure include a method, comprising obtaining, by a processing system including a processor, a processing capacity associated with a machine learning model and obtaining, by the processing system, a memory capacity associated with the machine learning model, and receiving, by the processing system, a processing capacity threshold via first user-generated input and receiving, by the processing system, a memory capacity threshold via second generated input. Further, the method can comprise provisioning, by the processing system, a head node and a first group of worker nodes based on the processing capacity, the memory capacity, the processing capacity threshold, and the memory capacity threshold, provisioning, by the processing system, a first portion of data engineering pipeline on each of the first group of worker nodes, and provisioning, by the processing system, a first portion of the machine learning model on each of the first group of worker nodes.

In one or more embodiments, ML models including natural language learning (NLP) models can be distributed among low cost central processing units (CPUs) for distributed inferencing utilizing such ML models. Such a distributed framework can be called a cluster. Further, if the ML models need to scaled, then the cluster framework can be scaled according to the complexity of the ML models as well as the intensiveness of the project in an efficient manner. Additional advantages of distributed/clustered framework provide a unified approach mitigating the need for different frameworks for different implementations of ML models that may increase complexity including more integration points, blockers, and increase cost of the build.

In one or more embodiments, deploying a ML model, also known as model deployment/serving/inferencing involves integrating a ML model into an existing production environment where it can take in an input and return an output. The purpose of deploying a ML model is to make the predictions from a trained ML model available to others, whether that be users, management or other systems. Model deployment is closely related to machine learning systems architecture, which refers to the arrangement and interactions of software components within a system to achieve a predefined goal.

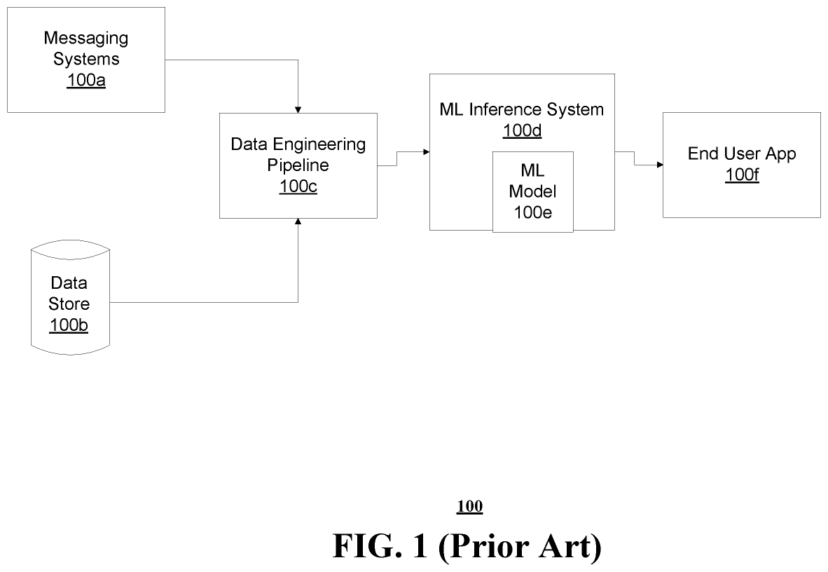

FIG. 1 is a block diagram illustrating an exemplary, non-limiting embodiment of the prior art. System 100 can include messaging systems 100a, a data store 100b, a data engineering pipeline 100c, a ML inference system 100d that includes a ML model 100e, and an end user application 100f. The data engineering pipeline 100c can include one or more data sources as well as message cleaning and transformation functions. Further, the system 100 can include an ML pipeline that includes a computer system (e.g., server(s)) to host the ML model 100e and expose serving endpoints. In addition, the system 100 can include an inference pipeline that includes one or more data destination or end user applications 100f.

There are major challenges in implementing system 100. These include the data engineering pipeline and the ML engineering pipeline need to be scaled in unison. The data engineering pipeline cannot scale independently from the ML engineering pipeline as it can overwhelm the ML engineering pipeline. Further challenges can include making a large number of hypertext transfer protocol (HTTP) calls for ML inferencing can consume significant system (e.g., processing and memory) and network resources, which can impact the performance of the end user application 100f. In many implementations of system 100, significant processing capacity and memory capacity can be allocated for high intensive projects. However, when implementing medium intensive or low intensive projects, the system 100 can inefficiently utilize the processing capacity and memory capacity that it was allocated.

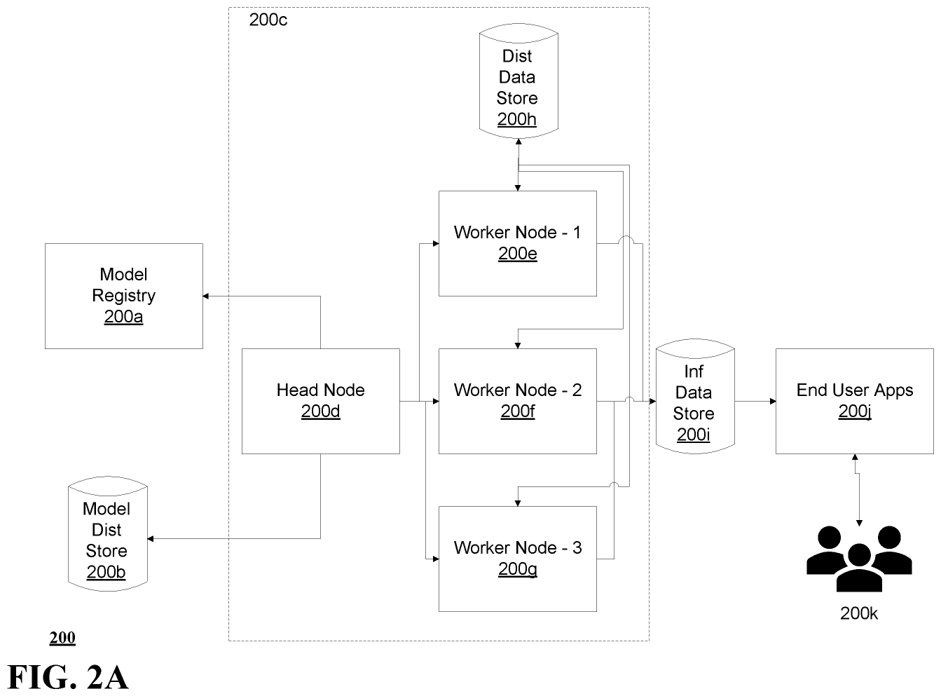

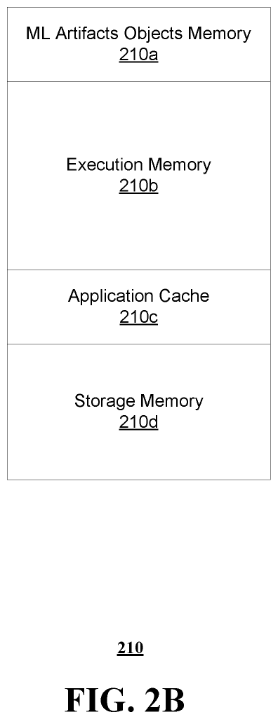

FIGS. 2A-2B are block diagrams illustrating an exemplary, non-limiting embodiments of a scalable machine learning model infrastructure in accordance with various aspects described herein. Referring to FIG. 2A, in one or more embodiments, system 200 can overcome the challenges associated with system 100 by including a ML model deployment system that provides a more efficient deployment of ML models at scale by implementing a distributed data computing architecture that merges the ML inference system with the data engineering pipeline. Further, trained ML model artifacts and inference code are treated as data objects, no different from distributed storage system/messaging objects.

In one or more embodiments, system 200 can include a model registry 200a and a model distributed data store 200b. Further, system 200 can include a distributed/cluster framework 200c that comprises a head node 200d accessing the model registry 200a and the model distributed data store 200b. In addition, the distributed/cluster framework 200c can include worker node-1 200e, worker node-2 200f, and worker node-3 200g communicatively coupled to head node 200d. Also, the distributed/cluster framework 200c can include a distributed data store 200h accessible by each of worker node-1 200e, worker node-2 200f, and worker node-3 200g. Further, system 200 can include an inference data store 200i accessible by each of worker node-1 200e, worker node-2 200f, and worker node-3 200g. In addition, the system 200 can include a group of end user applications 200j associated with users 200k, each of which able to access the inference data store 200i.

In one or more embodiments, the distributed/cluster framework 200c can include a cluster manager system to manage head node 200d and each of worker node-1 200e, worker node-2 200f, and worker node-3 200g. Further, head node 200d is responsible for loading trained ML model artifacts and inference code from model registry 200a and the model distributed data store 200b and serialize (distribute) them to each of worker node-1 200e, worker node-2 200f, and worker node-3 200g. This process can be performed only once, when the cluster starts implementing the machine learning model. In some embodiments, a head node 200d can have a replicated failover. That is, if one head node is overwhelmed and crashes, the failover allows another head node to take over. This is made possible by syncing the metadata between head nodes (worker nodes associated, tasks completed information) at regular intervals. Further, each of worker node-1 200e, worker node-2 200f, and worker node-3 200g deserialize the model artifacts and inference code and stores it in worker node memory as shown in FIG. 2B. Referring to FIG. 2B, in one or more embodiments, system 210 can include a memory allocation of a worker node that comprises ML artifacts objects memory 210a, execution memory 210b, application cache 210c, and storage memory 210d.

Referring back to FIG. 2A, in one or more embodiments, each of worker node-1 200e, worker node-2 200f, and worker node-3 200g process the incoming data from distributed data store 200h or messaging system and applies inference code to it. Further, data with inferences added is stored back in distributed data store 200h or messaging system available to users for consumption. In one or more embodiments, system 200 can be deployed and scaled efficiently with models from the registry/model store without needing a dedicated ML inference pipeline that can inefficiently use computer and network resources.

In one or more embodiments, system 200 can implement a method for ML model deployment comprising of receiving a machine learning model that trained external to the cluster framework 200c, automatically analyzing the ML model for size, computational complexity, data schema, dependencies, and accuracy metrics, and based on this analysis, preparing the ML model for execution within the data engineering platform by serializing ML artifacts and inference code, and deploying the prepared ML model on the cluster framework 200c instead of a dedicated machine learning engineering pipeline. Further embodiments can include leveraging memory as a model artifacts store while inferencing. Artifact sizes (which can be handled without scaling issues) can be less than 10 GB (e.g., memory capacity threshold), for example suitable for low intensive to medium intensive scale ML models. Additional embodiments can include, as the ML engineering pipeline is merged with data engineering pipeline, reliance on HTTP endpoint invocations are eliminated and data loss is prevented. In some embodiments, single point scaling can be achieved by adding more worker nodes to cluster framework 200c and sudden bursts of data from data sources can be efficiently managed.

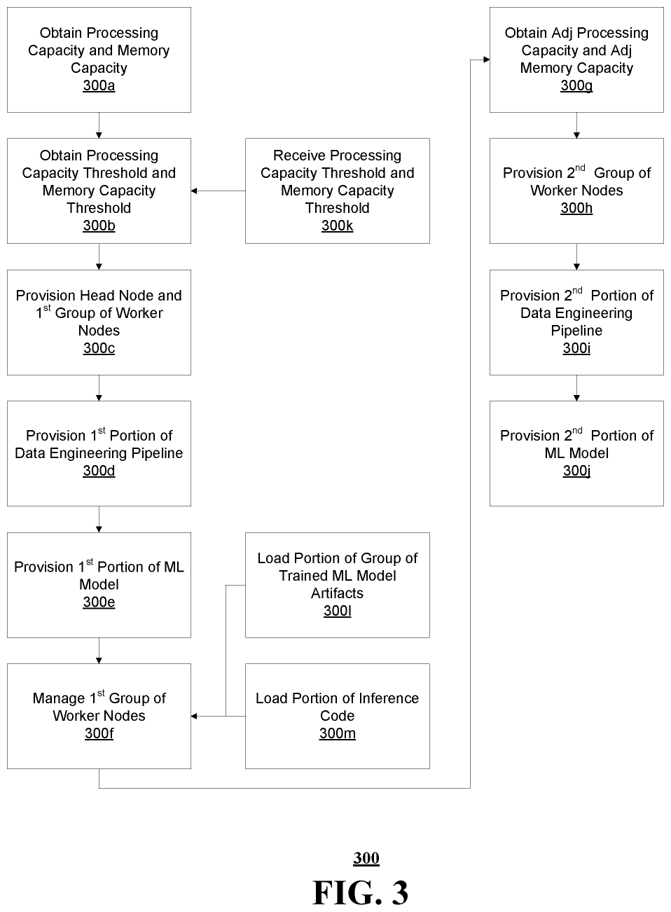

FIG. 3 depicts an illustrative embodiment of a method 300 in accordance with various aspects described herein. In one or more embodiments, aspects of method 300 can be implemented by a group of servers. Method 300 can include the group of servers, at 300a, obtaining a processing capacity associated with a machine learning model and obtaining a memory capacity associated with the machine learning model. Further, the method 300 can include the group of servers, at 300b, obtaining a processing capacity threshold and obtaining a memory capacity threshold. In some embodiments, memory of a processing node (e.g., worker node) can be divided into two parts, execution memory and storage memory, and each one is allocated 50% of the total available memory. For example, if a worker node is allocated 32 GB of RAM, 16 GB can be used to load the model in memory and 16 GB is allocated for running code using the model. In other embodiments, AI/ML models can be used to predict the best threshold for processing capacity and memory capacity. In further embodiments, the processing capacity threshold and/or the memory capacity threshold can be dependent on the end user applications and/or the type of problems being solved. Note, when the model is loaded in the worker node memory, code interactions with the ML model become memory based instead of running HTTP calls. Thus, the data, inference code, and ML model all stay together within one computing system (or virtual machine) eliminating the need for HTTP calls. In addition, the method 300 can include the group of servers, at 300c, provisioning a head node and a first group of worker nodes based on the processing capacity, the memory capacity, the processing capacity threshold, and the memory capacity threshold. Also, the method 300 can include the group of servers, at 300d, provisioning a first portion of data engineering pipeline on each of the first group of worker nodes. Further, the method 300 can include the group of servers, at 300e, provisioning a first portion of the machine learning model on each of the first group of worker nodes. In addition, the method 300 can include the group of servers, at 300f, managing, by the head node, the first group of worker nodes.

In one or more embodiments, the method 300 can include the group of servers, at 300l, loading, by the head node, a portion of a group of trained machine learning model artifacts on each of the first group of worker nodes. Further, the method 300 can include the group of servers, at 300m, loading, by the head node, inference code on each of the first group of worker nodes. In some embodiments, the managing of the first group of worker nodes comprises loading, by the head node, a portion of a group of trained machine learning model artifacts on each of the first group of worker nodes. In further embodiments, the managing of the first group of worker nodes comprises loading, by the head node, the inference code on each of the first group of worker nodes.

In one or more embodiments, the method 300 can include the group of servers, at 300g, obtaining an adjusted processing capacity associated with the machine learning model and obtaining an adjusted memory capacity associated with the machine learning model. Further, the method 300 can include the group of servers, at 300h, provisioning a second group of worker nodes based on the adjusted processing capacity, the adjusted memory capacity, the processing capacity threshold, and the memory capacity threshold. In addition, the method 300 can include the group of servers, at 300i, provisioning a second portion of data engineering pipeline on each of the second group of worker nodes. Also, the method 300 can include the group of servers, at 300j, provisioning a second portion of the machine learning model on each of the second group of worker nodes. In some embodiments, each of the first group of worker nodes is implemented by a virtual machine instantiated by one or more of the group of servers and each of the second group of worker nodes is implemented by a virtual machine instantiated by one or more of the group of servers.

In one or more embodiments, the method 300 can include the group of servers, at 300k, receiving the processing capacity threshold via a first user-generated input and receiving the memory capacity threshold via a second user-generated input. In some embodiments, the obtaining of the processing capacity threshold and obtaining the memory capacity threshold comprises receiving the processing capacity threshold via a first user-generated input and receiving the memory capacity threshold via a second user-generated input. The first user-generated input and the second user-generated can be provided by administration personnel from their associated computing devices (e.g., laptop computer, desktop computer, mobile phone, tablet computer, etc.).

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. In some embodiments, one or more blocks can be performed in response to one or more other blocks.

Further, portions of some embodiments can be combined with portions of other embodiments.

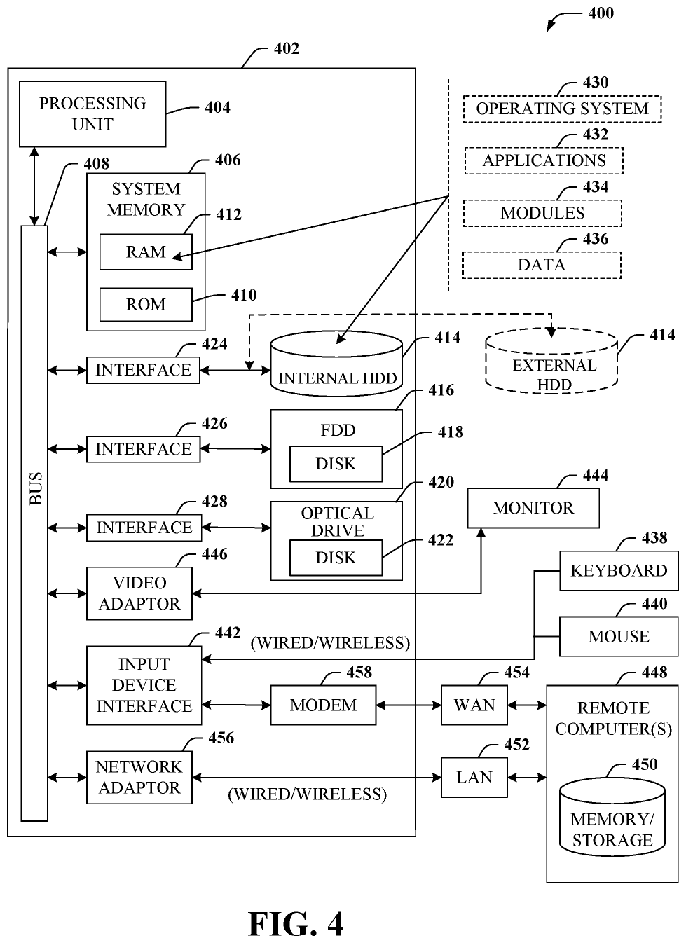

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, computing environment 400 can facilitate in whole or in part provisioning a scalable machine learning model infrastructure. Each of the group of servers that host or manage portions of the scalable machine learning model infrastructure comprises the computing environment 400 including the model registry 200a, model distribution data store 200b, head node 200d, worker node-1 200e, worker node-1 200e, worker node-2 200f, worker node-3 200g, distribution data store 200h, inference data store 200i, and each of the end user applications 200j.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a processing capacity associated with a machine learning model and obtaining a memory capacity associated with the machine learning model;
obtaining a processing capacity threshold and obtaining a memory capacity threshold;
provisioning a head node and a first group of worker nodes based on the processing capacity, the memory capacity, the processing capacity threshold, and the memory capacity threshold;
provisioning a first portion of data engineering pipeline on each of the first group of worker nodes; and
provisioning a first portion of the machine learning model on each of the first group of worker nodes.

2. The device of claim 1, wherein the operations comprise managing, by the head node, the first group of worker nodes.

3. The device of claim 2, wherein the managing of the first group of worker nodes comprises loading, by the head node, a portion of a group of trained machine learning model artifacts on each of the first group of worker nodes.

4. The device of claim 2, wherein the managing of the first group of worker nodes comprises loading, by the head node, inference code on each of the first group of worker nodes.

5. The device of claim 2, wherein the operations comprise obtaining an adjusted processing capacity associated with the machine learning model and obtaining an adjusted memory capacity associated with the machine learning model.

6. The device of claim 5, wherein the operations comprise provisioning a second group of worker nodes based on the adjusted processing capacity, the adjusted memory capacity, the processing capacity threshold, and the memory capacity threshold.

7. The device of claim 6, wherein the operations comprise:
provisioning a second portion of data engineering pipeline on each of the second group of worker nodes; and
provisioning a second portion of the machine learning model on each of the second group of worker nodes.

8. The device of claim 1, wherein each of the first group of worker nodes is implemented by a virtual machine.

9. The device of claim 1, wherein the obtaining of the processing capacity threshold and obtaining the memory capacity threshold comprises receiving the processing capacity threshold via a first user-generated input and receiving the memory capacity threshold via a second user-generated input.

10. A non-transitory machine-readable medium, comprising executable instructions that, when executed by a processing system including a processor, facilitate performance of operations, the operations comprising:
obtaining a processing capacity associated with a machine learning model and obtaining a memory capacity associated with the machine learning model;
provisioning a head node and a first group of worker nodes based on the processing capacity, and the memory capacity;
provisioning a first portion of data engineering pipeline on each of the first group of worker nodes; and
provisioning a first portion of the machine learning model on each of the first group of worker nodes.

11. The non-transitory machine-readable medium of claim 10, wherein the operations further comprise obtaining a processing capacity threshold and obtaining a memory capacity threshold.

12. The non-transitory machine-readable medium of claim 11, wherein the obtaining of the processing capacity threshold and obtaining the memory capacity threshold comprises receiving the processing capacity threshold via a first user-generated input and receiving the memory capacity threshold via a second user-generated input.

13. The non-transitory machine-readable medium of claim 11, wherein the provisioning of the head node and the first group of worker nodes comprises provisioning the head node and the first group of worker nodes based on the processing capacity threshold and the memory capacity threshold.

14. The non-transitory machine-readable medium of claim 10, wherein the operations comprise managing, by the head node, the first group of worker nodes.

15. The non-transitory machine-readable medium of claim 14, wherein the managing of the first group of worker nodes comprises loading, by the head node, a portion of a group of trained machine learning model artifacts on each of the first group of worker nodes.

16. The non-transitory machine-readable medium of claim 14, wherein the managing of the first group of worker nodes comprises loading, by the head node, inference code on each of the first group of worker nodes.

17. The non-transitory machine-readable medium of claim 10, wherein each of the first group of worker nodes is implemented by a virtual machine.

18. A method, comprising:
obtaining, by a processing system including a processor, a processing capacity associated with a machine learning model and obtaining, by the processing system, a memory capacity associated with the machine learning model;
receiving, by the processing system, a processing capacity threshold via first user-generated input and receiving, by the processing system, a memory capacity threshold via second generated input;
provisioning, by the processing system, a head node and a first group of worker nodes based on the processing capacity, the memory capacity, the processing capacity threshold, and the memory capacity threshold;
provisioning, by the processing system, a first portion of data engineering pipeline on each of the first group of worker nodes; and
provisioning, by the processing system, a first portion of the machine learning model on each of the first group of worker nodes.

19. The method of claim 18, comprising loading, by the processing system including the head node, a portion of a group of trained machine learning model artifacts on each of the first group of worker nodes.

20. The method of claim 18, comprising loading, by the processing system including the head node, inference code on each of the first group of worker nodes.
